(19) United States
(12) Patent Application Publication
(10) Pub. No.: US 2026/0354341 A1
(43) Pub. Date: Nov. 12, 2026

(54) PET FEEDER

(71) Applicant: Beijing Zhirun Technology Co., Ltd., Beijing (CN)

(72) Inventor: Zheng QIAO, Shenzhen (CN)

(21) Appl. No.: 19/733,852

(22) Filed: Jul. 7, 2026

(30) Foreign Application Priority Data
Jun. 22, 2026 (CN) 202620926775.X

(51) Int. Cl. A01K 5/02; A01K 5/01

(52) U.S. Cl. CPC A01K 5/0225; A01K 5/0114

(57) ABSTRACT

A pet feeder, including: a grain storage container, a distribution assembly and a drive assembly. The grain storage container defines an accommodating space; a bottom of the grain storage container is provided with a grain outlet in communication with the accommodating space. The distribution assembly is rotatable between a first position and a second position. In the first position the distribution assembly is located below the grain outlet to receive grain therefrom. In the second position at least a portion of the distribution assembly extends outwardly beyond a front side wall of the grain storage container to allow access by a pet. The drive assembly is configured to drive the distribution assembly to rotate between the first position and the second position.

### CROSS-REFERENCE TO RELATED APPLICATIONS

The application claims priority to Chinese Patent Application No.202620926775.X, filed on Jun. 22, 2026 in the China National Intellectual Property Administration, the entire disclosure of which is hereby incorporated by reference.

### TECHNICAL FIELD

The present disclosure relates to the technical field of pet supplies, in particular to a manually controllable pet feeder.

### BACKGROUND

With the improvement of people's living standards and spiritual needs, keeping pets has become a common phenomenon, and there is an urgent need for a convenient feeder capable of quantitatively supplying food to pets. Manual pet feeders have wide applications in daily life due to their advantages of requiring no power supply, low cost, and simple operation.

At present, existing pet feeders on the market mainly rely on a feeding bowl supported by a slide rail structure for dispensing food. Some slide rails cannot withstand heavier pet food, which may cause damage to the slide rails. Moreover, after multiple sliding operations, the slide rails inevitably suffer from varying degrees of wear. The slide rail structure is usually relatively complex, resulting in high manufacturing process difficulty and high production costs.

### SUMMARY

In order to overcome the deficiencies of the prior art, the present disclosure provides a pet feeder with a simple structure and convenient operation.

To realize the above objective, the present disclosure provides a pet feeder, including: a grain storage container defining an accommodating space, wherein a bottom of the grain storage container is provided with a grain outlet in communication with the accommodating space; a distribution assembly rotatable between a first position and a second position, wherein in the first position the distribution assembly is located below the grain outlet to receive grain therefrom, and in the second position at least a portion of the distribution assembly extends outwardly beyond a front side wall of the grain storage container to allow access by a pet; and a drive assembly configured to drive the distribution assembly to rotate between the first position and the second position.

The beneficial effects of the present disclosure are as follows: Through the arrangement of the above structure, the accommodating space defined by the grain storage container is used to store pet food, and the grain outlet is located at the bottom of the grain storage container, so that the pet food falls into the distribution assembly under the action of gravity. The drive assembly is in transmission connection with the distribution assembly, and the drive assembly is used to drive the distribution assembly to rotate between a first position and a second position. Specifically, the drive assembly can drive the distribution assembly to rotate from the first position to the second position, or reversely rotate from the second position back to the first position. When the pet feeder is in the initial state, the distribution assembly remains at the first position. At this time, the distribution assembly as a whole is located below the grain outlet, and the pet food in the accommodating space falls into the distribution assembly until the preset feeding amount is reached. After the drive assembly drives the distribution assembly to rotate from the first position to the second position, part of the distribution assembly is exposed to the front outer side of the grain storage container, so that the pet can lower its head to eat.

### BRIEF DESCRIPTION OF DRAWINGS

In order to more clearly illustrate the technical solutions in the embodiments of the present disclosure, the drawings required for use in the description of the embodiments will be briefly introduced below. The drawings in the following description are merely some embodiments of the present disclosure. For those of ordinary skill in the art, other drawings can also be obtained according to these drawings without creative labor.

The present disclosure will be further described below in conjunction with the drawings and embodiments.

FIG. 1 is a schematic structural diagram of a pet feeder according to an embodiment of the present disclosure at a first position, viewed from one perspective.

FIG. 2 is a schematic structural diagram of the pet feeder according to an embodiment of the present disclosure at the first position, viewed from another perspective.

FIG. 3 is a schematic structural diagram of the pet feeder according to an embodiment of the present disclosure at a second position.

FIG. 4 is a partial side view of the pet feeder according to an embodiment of the present disclosure at the first position.

FIG. 5 is a partial side view of the pet feeder according to an embodiment of the present disclosure at the second position.

FIG. 6 is a top view of the pet feeder according to an embodiment of the present disclosure at the first position.

FIG. 7 is a top view of the pet feeder according to an embodiment of the present disclosure at the second position.

FIG. 8 is a cross-sectional view of the pet feeder according to an embodiment of the present disclosure at the first position.

FIG. 9 is a cross-sectional view of the pet feeder according to an embodiment of the present disclosure at the second position.

FIG. 10 is a schematic exploded structural view of the pet feeder according to an embodiment of the present disclosure at the first position, viewed from one perspective.

FIG. 11 is a schematic exploded structural view of the pet feeder according to an embodiment of the present disclosure at the first position, viewed from another perspective.

FIG. 12 is a partial structural schematic diagram of the pet feeder according to an embodiment of the present disclosure at the first position, viewed from one perspective.

FIG. 13 is a partial structural schematic diagram of the pet feeder according to an embodiment of the present disclosure at the first position, viewed from another perspective.

FIG. 14 is a partial structural schematic diagram of the pet feeder according to an embodiment of the present disclosure at the second position, viewed from one perspective.

FIG. 15 is a partial structural schematic diagram of the pet feeder according to an embodiment of the present disclosure at the second position, viewed from another perspective.

### DESCRIPTION OF THE REFERENCE NUMERALS

100, grain storage container; 110, accommodating space; 121, grain outlet; 122, grain inlet; 130, rotating channel; 131, fixed plate; 132, limiting plate; 1321, second opening; 1322, sealing gasket; 141, first through hole; 142, second through hole; 150, housing; 151, rotation space; 160, guide member; 170, sealing cover; 171, locking member; 180, observation window; 200, distribution assembly; 210, rotating plate; 211, first opening; 220, feeding bowl; 300, drive assembly; 310, drive shaft; 311, first end; 312, second end; 313, handle; 400, support assembly; 410, support component.

### DETAILED DESCRIPTION OF THE EMBODIMENTS

In order to make the above objects, features and advantages of the present application more obvious and understandable, the specific embodiments of the present application will be described in detail below with reference to the accompanying drawings. In the following description, numerous specific details are set forth in order to provide a full understanding of the present application. However, the present application can be implemented in many other ways different from those described herein, and those skilled in the art can make similar improvements without departing from the connotation of the present application. Therefore, the present application is not limited by the specific embodiments disclosed below.

In the description of the present application, it should be understood that if the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. appear, these terms indicate the orientation or positional relationship based on the orientation or positional relationship shown in the drawings, and are only for the convenience of describing the present application and simplifying the description, rather than indicating or implying that the device or element referred to must have a specific orientation, be constructed and operated in a specific orientation, and therefore cannot be understood as a limitation of the present application.

In addition, if the terms “first” and “second” appear, these terms are used for descriptive purposes only and cannot be understood as indicating or implying relative importance or implicitly indicating the number of technical features indicated. Thus, a feature defined as “first” or “second” may explicitly or implicitly include at least one of the features. In the description of the present application, if the term “plurality” appears, the meaning of “plurality” is at least two, for example, two, three, etc., unless otherwise clearly and specifically defined.

In the present application, unless otherwise clearly specified and limited, if the terms “install”, “connect”, “link”, “fix”, etc. appear, these terms should be understood in a broad sense. For example, it can be a fixed connection, a detachable connection, or an integral connection; it can be a mechanical connection or an electrical connection; it can be a direct connection or an indirect connection through an intermediate medium, and it can be the internal communication of two elements or the interaction relationship between two elements, unless otherwise clearly defined. For those of ordinary skill in the art, the specific meanings of the above terms in the present application can be understood according to specific circumstances.

In the present application, unless otherwise clearly specified and limited, if there is a description such as a first feature being “on” or “under” a second feature, its meaning may be that the first and second features are in direct contact, or that the first and second features are in indirect contact through an intermediate medium. Moreover, the first feature being “above”, “over” and “on” the second feature may mean that the first feature is directly above or obliquely above the second feature, or simply means that the first feature is horizontally higher than the second feature. The first feature being “below”, “under” and “beneath” the second feature may mean that the first feature is directly below or obliquely below the second feature, or simply means that the first feature is horizontally lower than the second feature.

It should be noted that if an element is referred to as being “fixed to” or “disposed on” another element, it may be directly on the other element or there may be a centered element. If an element is considered to be “connected to” another element, it may be directly connected to the other element or there may be a centered element at the same time. If present, the terms “vertical”, “horizontal”, “upper”, “lower”, “left”, “right” and similar expressions used in the present application are for illustrative purposes only and do not mean that they are the only embodiments.

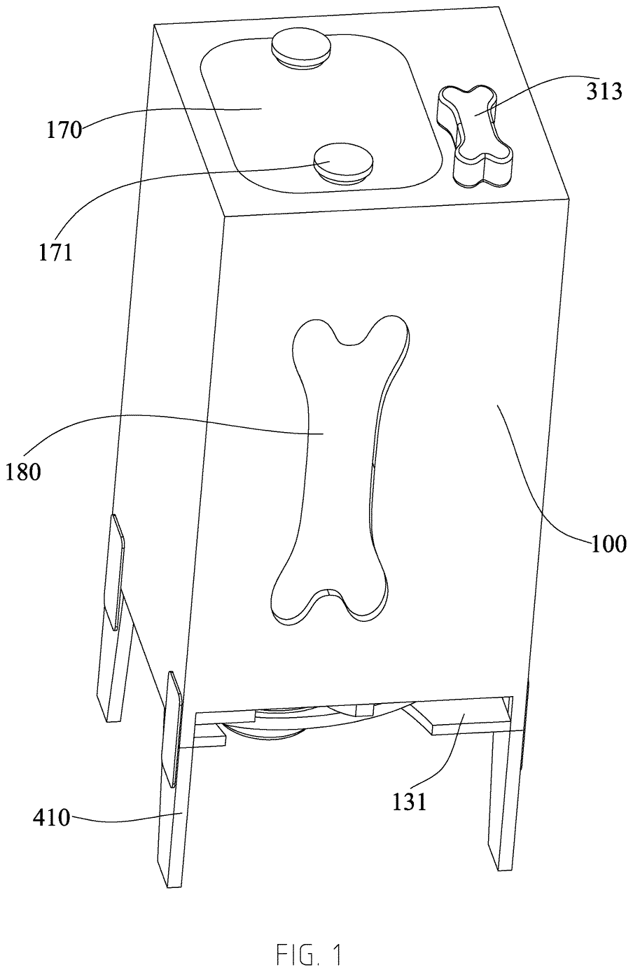

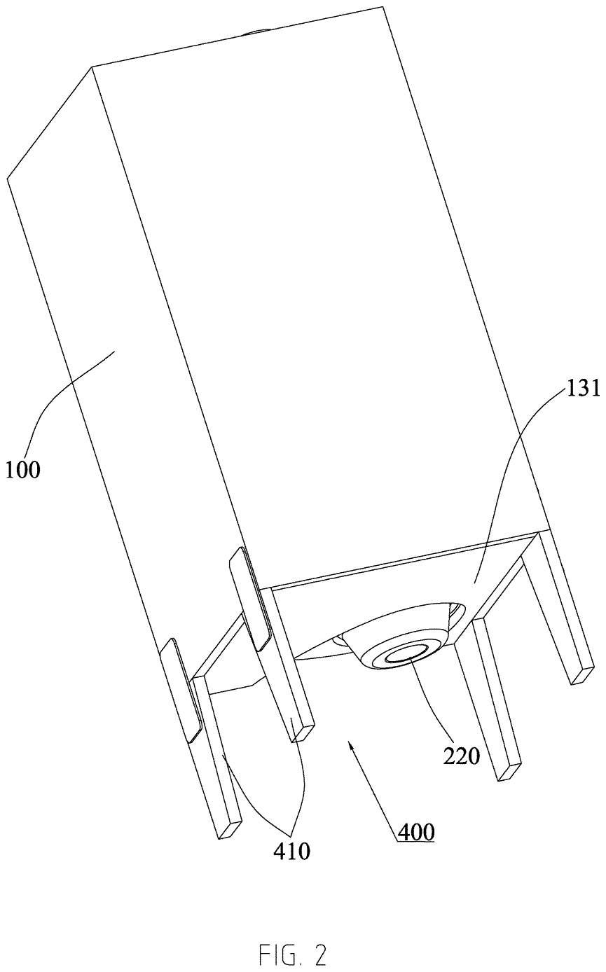

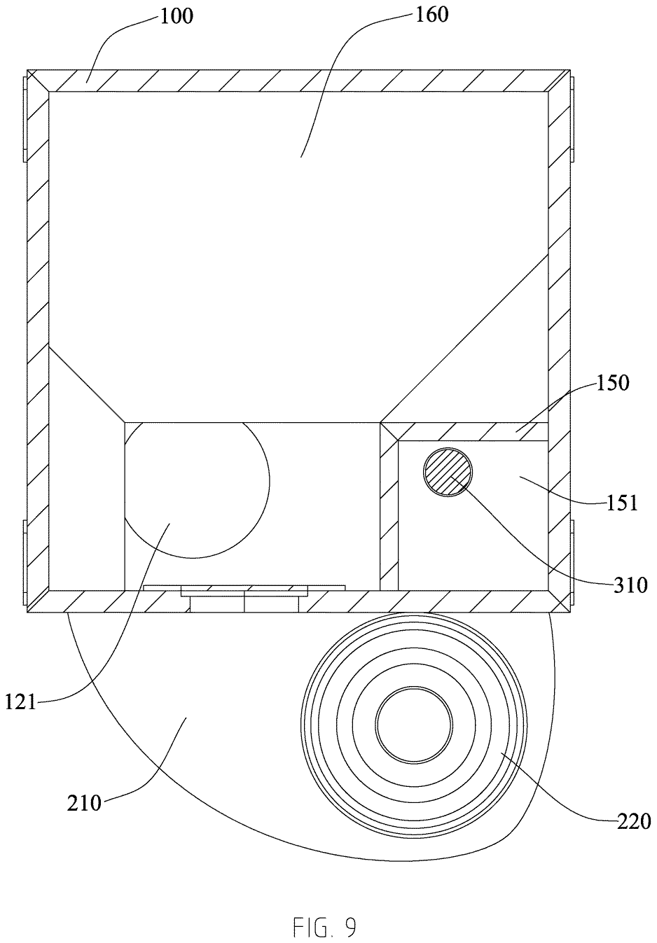

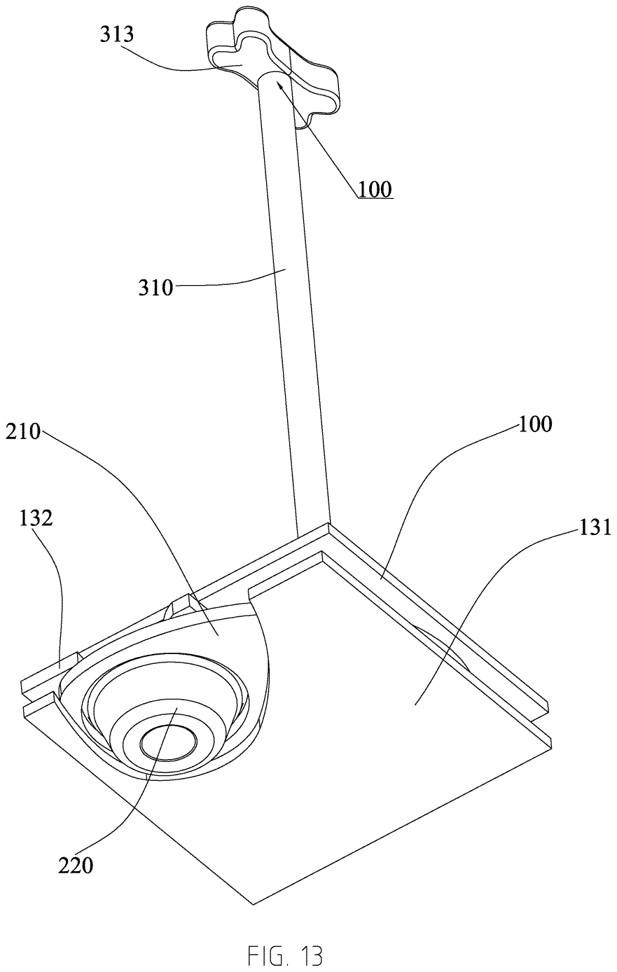

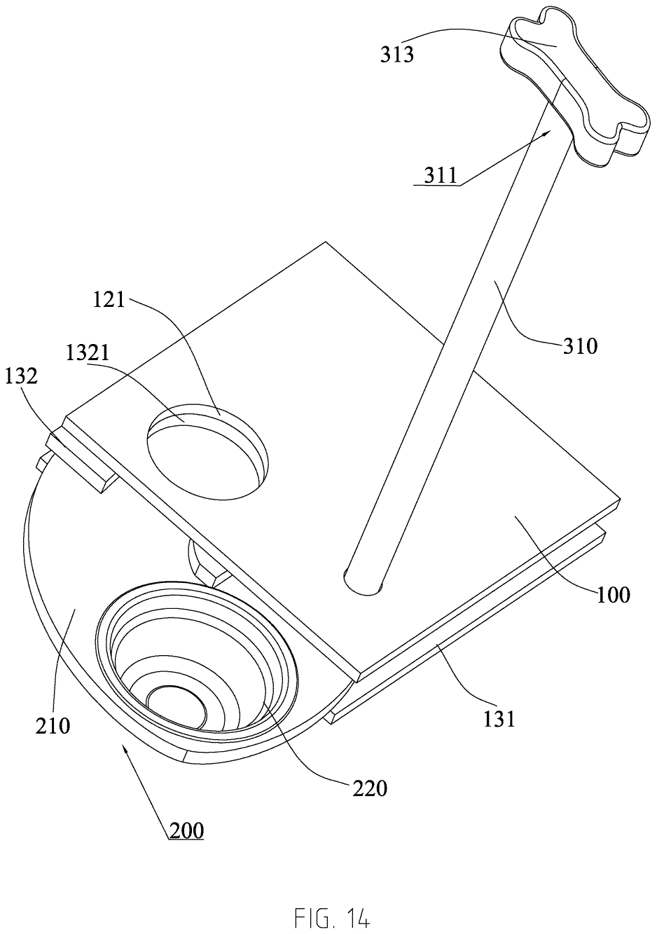

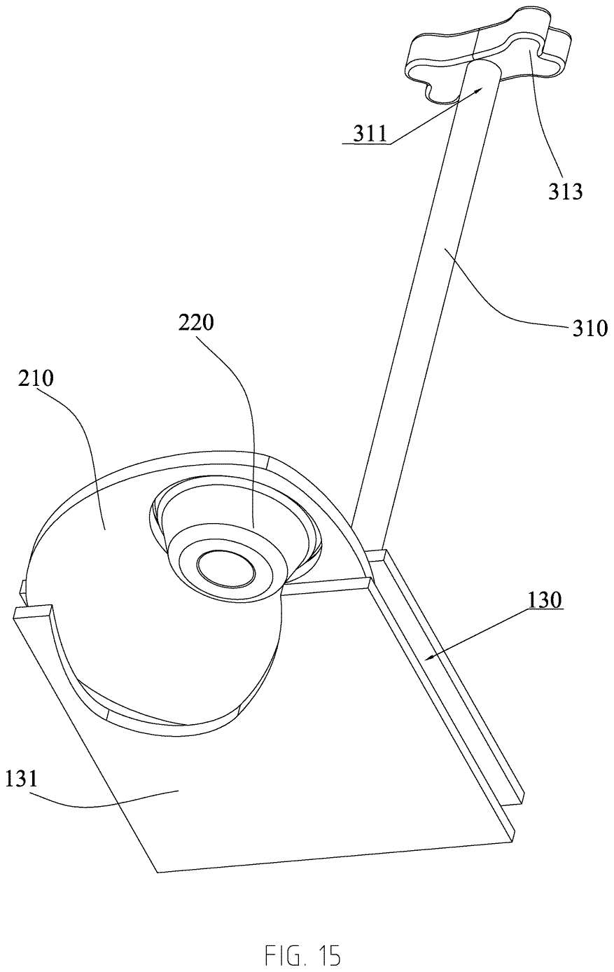

Referring to FIGS. 1 to 15, a pet feeder includes: a grain storage container 100 defining an accommodating space 110, wherein a bottom portion of the grain storage container 100 is provided with a grain outlet 121 in communication with the accommodating space 110; a distribution assembly 200 having a first position and a second position, wherein in the first position the distribution assembly 200 is located below the grain outlet 121, and in the second position at least a portion of the distribution assembly 200 extends outwardly beyond the front side wall of the grain storage container 100; a drive assembly 300 configured to drive the distribution assembly 200 to rotate between the first position and the second position.

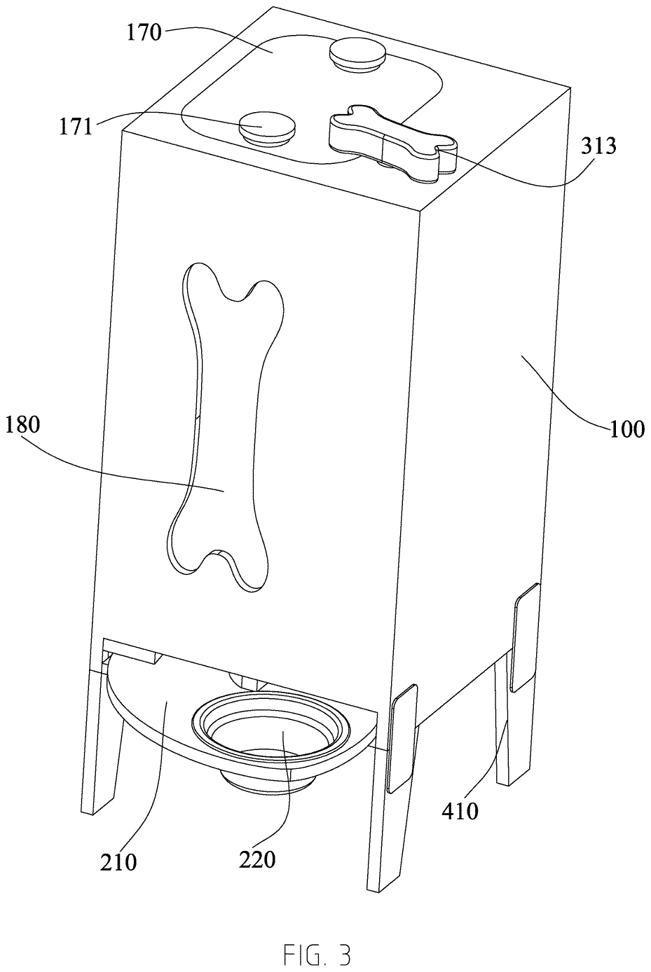

Through the arrangement of the above structure, as shown in FIGS. 1 to 3, FIGS. 1 and 2 illustrate the state in which the distribution assembly 200 is located at the first position, in which the distribution assembly 200 as a whole is positioned below the grain outlet 121. At this time, the distribution assembly 200 receives pet food falling from the grain outlet 121, forming a grain storage and receiving state. FIG. 3 illustrates the state in which the distribution assembly 200 is located at the second position, in which a portion of the distribution assembly 200 protrudes outwardly from the front side wall of the grain storage container 100, thereby enabling a pet to directly access and consume food from the distribution assembly 200, forming a pet feeding state. The accommodating space 110 defined by the grain storage container 100 is used for storing pet food, and the grain outlet 121 is located at the bottom of the grain storage container 100 so that, under the action of gravity, pet food falls into the distribution assembly 200. The drive assembly 300 is in transmission connection with the distribution assembly 200 and is configured to drive the distribution assembly 200 to rotate between the first position and the second position. Specifically, the drive assembly 300 can drive the distribution assembly 200 to rotate from the first position to the second position, or to rotate reversely from the second position back to the first position. When the pet feeder is in an initial state, the distribution assembly 200 is maintained at the first position. At this time, the distribution assembly 200 as a whole is located below the grain outlet 121, and pet food in the accommodating space 110 falls into the distribution assembly 200 until a preset feeding amount is reached. After the drive assembly 300 drives the distribution assembly 200 to rotate from the first position to the second position, a portion of the distribution assembly 200 is exposed to the exterior of the front side wall of the grain storage container 100, allowing the pet to lower its head to eat.

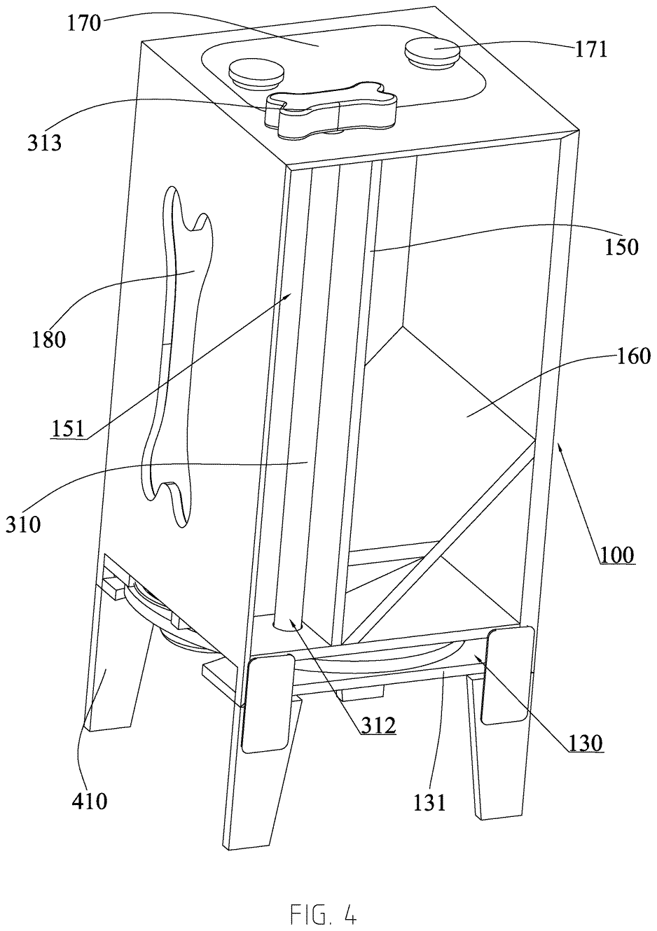

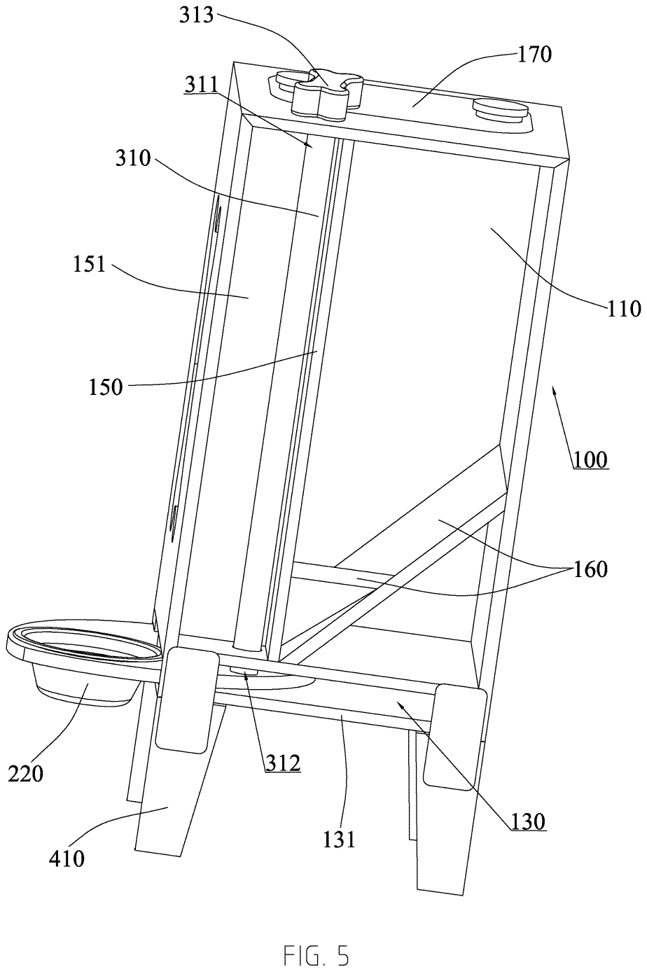

In this embodiment, the distribution assembly 200 includes a rotating plate 210 and a feeding bowl 220 fixedly connected to the rotating plate 210. In the first position, the feeding bowl 220 is located below the grain outlet 121. The drive assembly 300 drives the rotating plate 210 to rotate between the first position and the second position so as to synchronously drive the feeding bowl 220 to rotate. Through the arrangement of the above structure, as shown in FIGS. 4 and 5, in the first position the rotating plate 210 is located at the bottom of the grain storage container 100, and the feeding bowl 220 is positioned directly below the grain outlet 121, capable of receiving pet food falling from the accommodating space 110. The drive assembly 300 is in transmission connection with the rotating plate 210 and is configured to drive the rotating plate 210 to rotate. When the drive assembly 300 drives the rotating plate 210 to rotate from the first position to the second position, the feeding bowl 220 is synchronously driven to rotate, so that the feeding bowl 220 is exposed at the front side wall of the grain storage container 100 for the pet to access food. After the pet has finished eating or the pet food in the feeding bowl has been consumed, the drive assembly 300 rotates such that the rotating plate 210 drives the feeding bowl 220 to reset to the first position, ready for the next feeding cycle.

In this embodiment, the drive assembly 300 includes a drive shaft 310, wherein the drive shaft 310 is connected to the rotating plate 210. Rotation of the drive shaft 310 causes the rotating plate 210 to rotate between the first position and the second position. Through the arrangement of the above structure, as shown in FIGS. 4 and 5, the drive shaft 310 is connected to the rotating plate 210. By rotating the drive shaft 310, the rotating plate 210 is caused to rotate from the first position to the second position. Specifically, the drive shaft 310 is arranged in a vertical direction and is connected to one side of the rotating plate 210. A user manually rotates the drive shaft 310, causing the rotating plate 210 to swing about the axis of the drive shaft 310, thereby driving the feeding bowl 220 to switch between the first position (grain storage and receiving position) and the second position (extended feeding position).

In this embodiment, the drive shaft 310 is provided with a first end 311 and a second end 312 connected to the rotating plate 210, and the first end 311 is movably connected to the grain storage container 100. Through the arrangement of the above structure, as shown in FIGS. 4 and 5 and FIGS. 10 and 11, the drive shaft 310 is provided with a first end 311 and a second end 312, the second end 312 is fixedly connected to the rotating plate 210, and the first end 311 is movably connected to the grain storage container 100. Specifically, when a user manually drives the drive shaft 310 to rotate about its own axis, the second end 312 drives the rotating plate 210 to rotate synchronously, thereby realizing the switching of the feeding bowl 220 between the first position and the second position.

In this embodiment, a fixed plate 131 is provided at the bottom of the grain storage container 100, and a bottom of the grain storage container 100 and the fixed plate 131 together define a rotating channel 130. In the first position, the rotating plate 210 is located in the rotating channel 130. In the second position, at least a portion of the rotating plate 210 is located in the rotating channel 130, and a side edge of the rotating plate 210 abuts against a front side wall of the grain storage container 100. Through the arrangement of the above structure, as shown in FIGS. 3 and 4, the fixed plate 131 is provided at the bottom of the grain storage container 100, and the bottom of the grain storage container 100 and the fixed plate 131 together define a rotating channel 130. Specifically, the fixed plate 131 is arranged parallel to and below the bottom of the grain storage container 100, forming a gap of a certain height therebetween, which constitutes the rotating channel 130. In the first position, the rotating plate 210 is located in the rotating channel 130; that is, when the feeder is in the grain storage and receiving state, the rotating plate 210 is entirely accommodated inside the rotating channel 130, the feeding bowl 220 is held below the grain outlet 121, and the rotating plate 210 is constrained by the rotating channel 130 so as to be less prone to rotational deviation. When the drive shaft 310 drives the rotating plate 210 to rotate outwardly to the maximum extended position, the side edge of the rotating plate 210 abuts against the front side wall of the grain storage container 100, forming a limiting structure that prevents over-rotation of the rotating plate 210. The rotating channel 130 not only provides accommodation space and movement guidance for the rotating plate 210, but also cooperates with the limiting structure to define the rotation range of the rotating plate 210, thereby enabling the distribution assembly 200 to rotate reliably between the two positions.

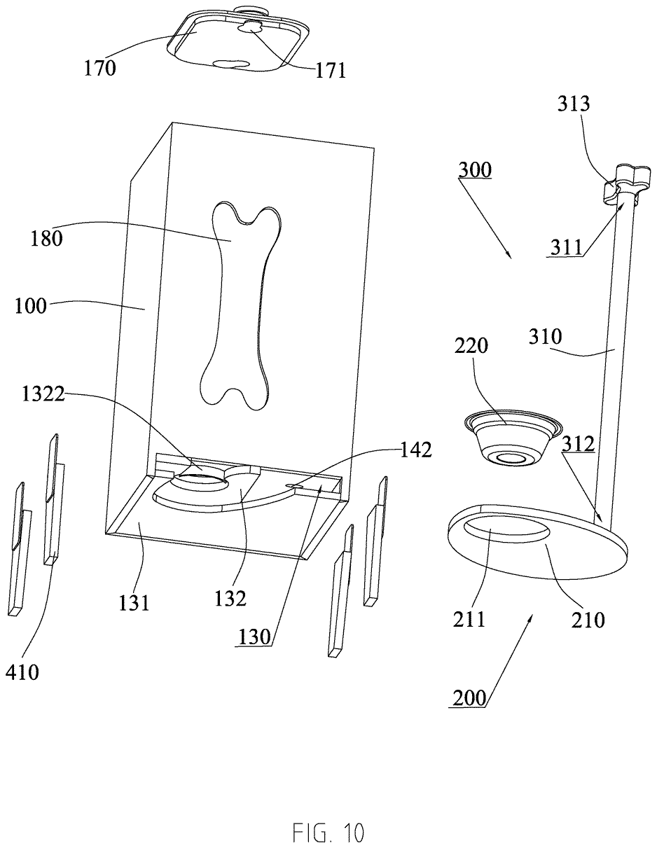

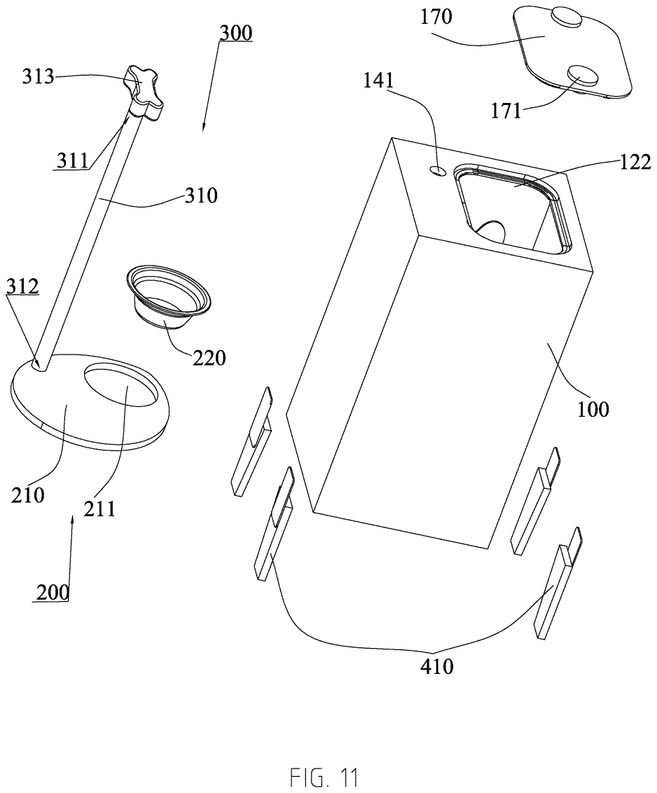

In this embodiment, a first through hole 141 is provided at the top of the grain storage container 100, and a second through hole 142 opposite to the first through hole 141 is provided at the bottom of the grain storage container 100. The first end 311 extends through the first through hole 141 to the top of the grain storage container 100, and the second end 312 extends through the second through hole 142 into the rotating channel 130. Through the arrangement of the above structure, as shown in FIGS. 10 and 11, the first end 311 of the drive shaft 310 extends through the first through hole 141 to the top of the grain storage container 100, and the second end 312 extends through the second through hole 142 into the rotating channel 130. Specifically, the first through hole 141 and the second through hole 142 are coaxially arranged in the vertical direction. The drive shaft 310 is arranged vertically, with its first end 311 extending upwardly out of the top surface of the grain storage container 100 for convenient direct operation by the user from above. The second end 312 extends downwardly into the rotating channel 130 and connects with the rotating plate 210. The drive shaft 310 longitudinally penetrates the entire grain storage container 100, allowing the user to manually rotate the first end 311 at the top of the grain storage container 100, thereby driving the drive shaft 310 to rotate about its own axis and causing the rotating plate 210 to switch between the first position and the second position, which in turn drives the rotation of the feeding bowl 220.

In this embodiment, a housing 150 is provided inside the grain storage container 100 surrounding the drive shaft 310. The housing 150 defines a rotation space 151 that allows the drive shaft 310 to rotate, and the rotation space 151 is not in communication with the accommodating space 110. Through the arrangement of the above structure, as shown in FIGS. 4-5 and FIGS. 8-9, the housing 150 is a hollow cylindrical structure coaxially surrounding the exterior of the drive shaft 310. The upper and lower ends of the housing 150 are respectively connected to the top wall and bottom wall of the grain storage container 100. On the one hand, the gap between the inner wall of the housing 150 and the inner wall of the grain storage container 100 constitutes the rotation space 151. On the other hand, the sealed connection between the housing 150 and the inner wall of the grain storage container 100 physically isolates the rotation space 151 from the accommodating space 110. The drive shaft 310 is completely separated from the pet food in the accommodating space 110 during rotation, thereby preventing pet food particles from entering gaps in the shaft and causing jamming or wear, while also preventing lubricant on the drive shaft 310 from contaminating the pet food, thus ensuring the hygiene and safety of the pet food.

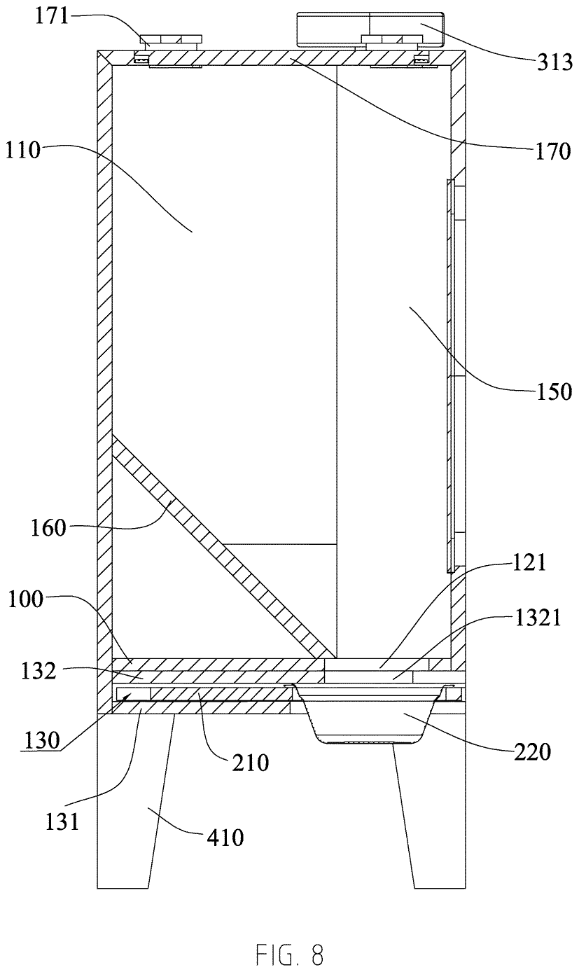

In this embodiment, the rotating plate 210 is provided with a first opening 211, against the outer periphery of which the feeding bowl 220 is detachably mounted. Through the arrangement of the above structure, as shown in FIGS. 8-11, when the distribution assembly 200 is in the first position, the rotating plate 210 is located directly below the bottom of the grain storage container 100. When the feeding bowl 220 is not placed, the first opening 211 on the rotating plate 210 is vertically aligned with the grain outlet 121. The rim of the feeding bowl 220 is detachably abutted against the outer periphery of the first opening 211, allowing pet food falling from the accommodating space 110 to fall directly into the feeding bowl 220. It should be noted that the first opening 211 is a through hole, and the feeding bowl 220 abuts against the outer periphery of the first opening 211 from the vertical direction of the rotating plate 210, so that the rim of the feeding bowl 220 is docked with the grain outlet 121, and pet food falls directly into the bowl. Due to the detachable connection between the feeding bowl 220 and the rotating plate 210, the user can conveniently remove the feeding bowl 220 for cleaning or replacement. Preferably, in the first position, the rotating plate 210 is located in the rotating channel 130, and part of the feeding bowl 220 is also located in the rotating channel 130. According to the volume of the feeding bowl 220, the shape of the fixed plate 131 may be adjusted accordingly. For example, when the feeding bowl 220 has a greater depth, the fixed plate 131 may be correspondingly provided with a local avoidance groove or opening so that the feeding bowl 220 does not interfere with the fixed plate 131 in the first position.

In this embodiment, the grain storage container 100 further includes a limiting plate 132, wherein the limiting plate 132 is located in the rotating channel 130, and the limiting plate 132 is positioned above the rotating plate 210.

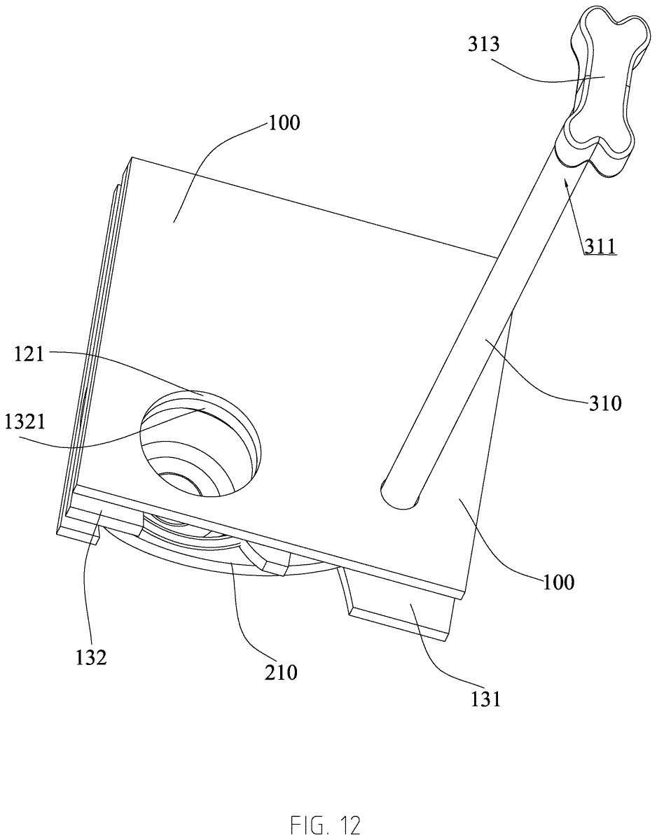

Through the arrangement of the above-described structure, as shown in FIGS. 12-15, a channel that is restricted in the vertical direction is formed between the limiting plate 132 and the fixed plate 131. When the rotating plate 210 is located within the rotating channel 130, the limiting plate 132 serves to restrict the displacement of the rotating plate 210 in the vertical direction. That is, the rotating plate 210 is clamped between the fixed plate 131 and the limiting plate 132 within the rotating channel 130, wherein the fixed plate 131 supports the rotating plate 210 from below, and the limiting plate 132 presses against the rotating plate 210 from above, thereby effectively preventing the rotating plate 210 from undergoing upward or downward tilting in either a moving or stationary state, and avoiding the spilling of pet food contained in the feeding bowl 220 due to shaking or the erroneous docking between the grain outlet 121 and the feeding bowl 220.

In this embodiment, the limiting plate 132 is provided with a second opening 1321, which communicates with the grain outlet 121 and the first opening 211, respectively.

Through the arrangement of the above-described structure, as shown in FIGS. 12-15, when the distribution assembly 200 is in the first position, the grain outlet 121, the second opening 1321, and the first opening 211 are sequentially aligned in the vertical direction, such that the pet food falling from the accommodating space 110 can sequentially pass through the grain outlet 121, the second opening 1321, and the first opening 211, and ultimately fall into the feeding bowl 220. It should be noted that the diameters of the first opening 211 and the second opening 1321 are larger than that of the grain outlet 121, which ensures that after the pet food falls from the grain outlet 121, it can smoothly pass through the second opening 1321 and the first opening 211 into the feeding bowl 220 without being blocked due to interference from the edges of the openings.

It should further be noted that a sealing gasket 1322 is provided on the outer periphery of the grain outlet 121 and the second opening 1321. In the first position, at least a portion of the sealing gasket 1322 is inserted into the feeding bowl 220, thereby ensuring that the pet food falls directly into the feeding bowl 220 under the action of gravity. In the second position, the sealing gasket 1322 abuts against the rotating plate 210 to seal the second opening, preventing the pet food from leaking through the gap between the limiting plate 132 and the rotating plate 210 via the second opening 1321.

In this embodiment, the distance between the limiting plate 132 and the fixed plate 131 is slightly greater than the thickness of the rotating plate 210.

Through the arrangement of the above-described structure, as shown in FIGS. 12-15, the vertical distance between the lower surface of the limiting plate 132 and the upper surface of the fixed plate 131 should be slightly greater than the thickness of the rotating plate 210, such that the rotating plate 210 can freely rotate horizontally between the limiting plate 132 and the fixed plate 131 while avoiding excessive displacement clearance in the vertical direction.

In this embodiment, the drive assembly 300 further includes a handle 313, wherein the handle 313 is connected to the first end 311.

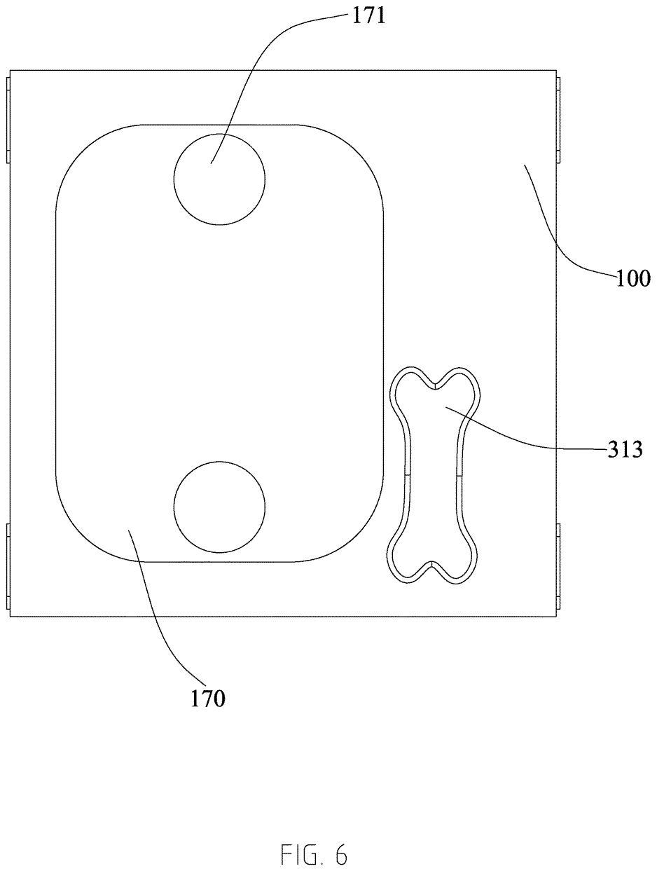

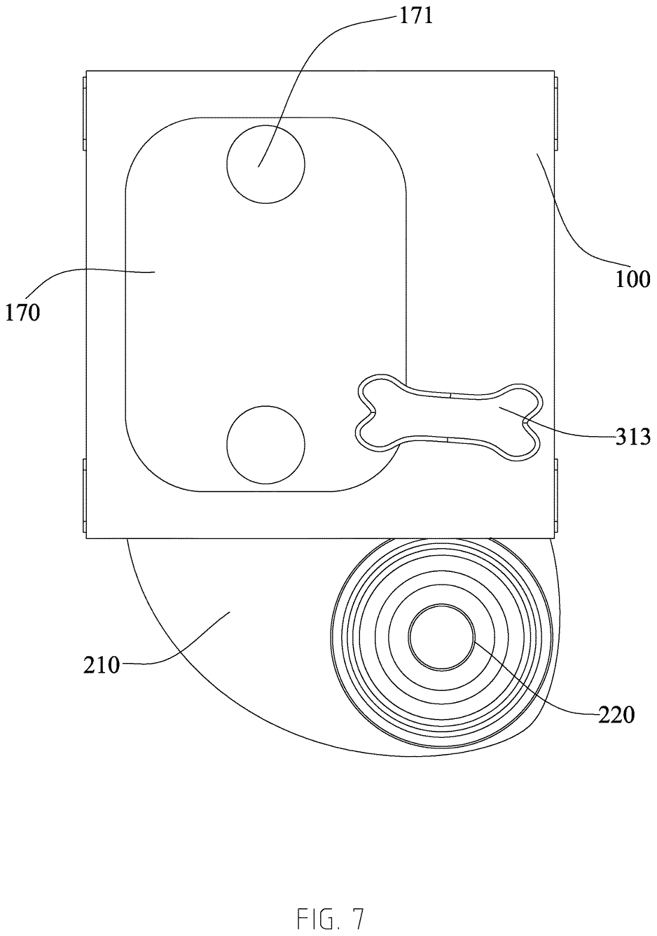

Through the arrangement of the above-described structure, as shown in FIGS. 6 and 7, by rotating the handle 313, a user can manually drive the drive shaft 310 to rotate, thereby driving the rotating plate 210 and the feeding bowl 220 to switch between the first position and the second position. When rotating from the first position to the second position, the free end of the handle 313 rotates by an angle of approximately 90°. When the handle 313 is not rotated, the feeding bowl 220 is completely located below the grain storage container 100; when the handle 313 is rotated by 90°, the feeding bowl 220 is fully exposed to the outside of the grain storage container 100. In addition, the user can control and adjust the extension amount of the feeding bowl 220 by rotating the handle 313 according to actual usage conditions. For example, rotating the handle 313 by 45° can cause the feeding bowl 220 to partially extend, thereby satisfying the feeding needs of small pets.

In this embodiment, the grain storage container 100 further includes a guide member 160, wherein the guide member 160 is located inside the grain storage container 100 and is arranged to be inclined toward the grain outlet 121.

Through the arrangement of the above-described structure, as shown in FIGS. 4 and 5, the guide member 160 is located inside the grain storage container 100 and is arranged inclined toward the grain outlet 121. Preferably, the guide member 160 is disposed at the bottom of the accommodating space 110 and is of a slope or arcuate surface structure, extending obliquely downward from the side inside the grain storage container 100 to the grain outlet 121, such that the pet food in the accommodating space 110 can automatically slide along the guide member 160 toward the grain outlet 121 under the action of gravity, thereby preventing the pet food from accumulating in the corners of the container and failing to be discharged smoothly.

In this embodiment, the grain storage container 100 is further provided with a grain inlet 122, wherein the grain inlet 122 communicates with the accommodating space 110.

Through the arrangement of the above-described structure, as shown in FIGS. 10 and 11, the grain inlet 122 communicates with the accommodating space 110. Preferably, the grain inlet 122 may be provided at the top or upper side wall of the grain storage container 100 for adding pet food into the accommodating space 110. A user can directly pour pet food into the grain storage container 100 through the grain inlet 122 without disassembling other components.

In this embodiment, the grain storage container 100 further includes a sealing cover 170, wherein the sealing cover 170 is connected to the grain storage container 100 to cover and close the grain inlet 122.

Through the arrangement of the above-described structure, as shown in FIGS. 10 and 11, the sealing cover 170 seals the grain inlet 122. When closed, the sealing cover 170 forms a tight sealing fit with the grain inlet 122. This effectively prevents external dust, moisture, or foreign objects from entering the accommodating space 110. It also prevents pet food odors from escaping and stops large pets from prying open the cover to steal food.

In this embodiment, the bottom of the sealing cover 170 is provided with a locking member 171, and the locking member 171 is rotated so that the locking member 171 abuts against the sealing cover 170 and the inner wall of the grain storage container 100, respectively.

Through the arrangement of the above-described structure, as shown in FIGS. 10 and 11, the locking member 171 includes a knob protruding from the top of the sealing cover 170 and a rotating piece located at the bottom of the sealing cover 170. The user rotates the knob at the top to drive the rotating piece at the bottom to rotate. When the rotating piece rotates to a certain angle, its two ends respectively abut against the bottom surface of the sealing cover 170 and the inner wall of the grain storage container 100, thereby locking the sealing cover 170 in the closed state and preventing the sealing cover 170 from disengaging from the grain storage container 100. By rotating the knob in the reverse direction to disengage the rotating piece from abutment with the inner wall of the grain storage container 100, the lock can be released and the sealing cover 170 opened, allowing pet food to be poured into the accommodating space 110.

In this embodiment, the grain storage container 100 is further provided with an observation window 180 located at the front end of the grain storage container 100.

Through the arrangement of the above-described structure, as shown in FIGS. 1 and 3, the observation window 180 may be made of a transparent material (such as transparent plastic or glass) and is mounted on the front side wall of the grain storage container 100. Through the observation window 180, the user can intuitively see the remaining amount of pet food in the accommodating space 110 without opening the grain storage container 100. In addition, the observation window 180 can also be used to observe the flow state of the pet food and whether there is any blockage at the grain outlet 121. Preferably, scale lines or remaining quantity markings may be provided on the observation window 180 to enable more accurate judgment of the remaining pet food.

In this embodiment, a support assembly 400 is further included, wherein the support assembly 400 is connected to the bottom of the grain storage container 100.

Through the arrangement of the above-described structure, the support assembly 400 is connected to the bottom of the grain storage container 100 and is used to stably support the grain storage container 100 on the ground or a tabletop. Preferably, the support assembly 400 raises the entire grain storage container 100 to a certain height, such that an appropriate gap is maintained between the bottom of the feeding bowl 220 and the supporting surface, thereby avoiding wear or contamination of the feeding bowl 220 caused by direct contact with the supporting surface.

In this embodiment, the grain storage container 100 has a rectangular parallelepiped structure.

Through the arrangement of the above-described structure, the grain storage container 100 is of a rectangular structure. The regular rectangular shape makes the layout of the internal accommodating space 110 more regular, which is beneficial to the storage of pet food and its flow in the vertical direction. At the same time, the rectangular structure facilitates the arrangement of components such as the grain outlet 121, the grain inlet 122, the observation window 180, and the drive shaft 310 on different side surfaces, thereby improving the assembly convenience and appearance coordination of the pet feeder.

In this embodiment, the support assembly 400 includes a plurality of support components 410, wherein the plurality of support components 410 are symmetrically arranged at the bottom of the grain storage container 100.

Through the arrangement of the above-described structure, the support assembly 400 includes a plurality of support components 410, which are symmetrically arranged at the bottom of the grain storage container 100. Optionally, the support components 410 may be support feet, upright columns, or pads, and their number is preferably four, respectively arranged at the four corners of the bottom of the grain storage container 100, forming a left-right symmetrical and front-rear symmetrical layout. Through the symmetrical arrangement, the support assembly 400 can evenly distribute the weight of the grain storage container 100 to the supporting surface. At the same time, the symmetrical structure ensures that the grain storage container 100 remains balanced when the feeding bowl 220 is rotated to the second position, preventing shaking caused by mutual pushing during the pet's feeding process. Preferably, the bottom of each support component 410 is provided with a non-slip pad to further enhance stability. Optionally, the support components 410 can also be designed as height-adjustable structures (via threaded adjustment) to adapt to uneven supporting surfaces and ensure that the pet feeder is always in a horizontal state.

The above descriptions provide one or more embodiments in conjunction with specific contents and do not limit the specific implementations of the present disclosure to these descriptions. Any modifications that are similar or identical to the method, structure, etc. of the present disclosure, or any technical deductions or replacements made on the premise of the inventive concept of the present disclosure, shall be deemed to fall within the protection scope of the present disclosure.

What is claimed is:

1. A pet feeder, comprising:
a grain storage container defining an accommodating space, wherein a bottom of the grain storage container is provided with a grain outlet in communication with the accommodating space;
a distribution assembly rotatable between a first position and a second position, wherein in the first position the distribution assembly is located below the grain outlet to receive grain therefrom, and in the second position at least a portion of the distribution assembly extends outwardly beyond a front side wall of the grain storage container to allow access by a pet; and
a drive assembly configured to drive the distribution assembly to rotate between the first position and the second position.

2. The pet feeder of claim 1, wherein the distribution assembly comprises a rotating plate and a feeding bowl connected to the rotating plate;
wherein, in the first position the feeding bowl is located below the grain outlet; and
wherein the drive assembly is configured to drive the rotating plate to rotate between the first position and the second position so as to drive the feeding bowl to rotate synchronously therewith.

3. The pet feeder of claim 2, wherein the drive assembly comprises a drive shaft connected to the rotating plate, wherein rotation of the drive shaft drives the rotating plate to rotate between the first position and the second position.

4. The pet feeder of claim 3, wherein the drive shaft has a first end and a second end, the second end is connected to the rotating plate, and the first end is movably connected to the grain storage container.

5. The pet feeder of claim 4, wherein a bottom of the grain storage container is provided with a fixed plate, wherein the bottom of the grain storage container and the fixed plate together define a rotating channel;
wherein, when in the first position, the rotating plate is located in the rotating channel; and
wherein, when in the second position, at least a portion of the rotating plate remains in the rotating channel while a side edge of the rotating plate abuts against the front side wall of the grain storage container.

6. The pet feeder of claim 5, wherein a top of the grain storage container is provided with a first through hole, and a bottom of the grain storage container is provided with a second through hole opposite the first through hole;
wherein the first end of the drive shaft passes through the first through hole and extends to the top of the grain storage container, and the second end passes through the second through hole and extends into the rotating channel.

7. The pet feeder of claim 3, wherein a housing is provided inside the grain storage container and surrounds the drive shaft;
wherein the housing defines a rotating space that allows the drive shaft to rotate therein; and
wherein the rotating space is isolated from and does not communicate with the accommodating space.

8. The pet feeder of claim 2, wherein the rotating plate is provided with a first opening, and the feeding bowl is detachably connected to an outer periphery of the first opening.

9. The pet feeder of claim 5, wherein the grain storage container further comprises a limiting plate located in the rotating channel and positioned above the rotating plate.

10. The pet feeder of claim 9, wherein the limiting plate is provided with a second opening, and the second opening is in communication with the grain outlet.

11. The pet feeder of claim 9, wherein a distance between the limiting plate and the fixed plate is slightly greater than a thickness of the rotating plate, thereby permitting the rotating plate to rotate freely in a horizontal direction between the limiting plate and the fixed plate while avoiding excessive displacement clearance in a vertical direction.

12. The pet feeder of claim 4, wherein the drive assembly further comprises a handle connected to the first end of the drive shaft.

13. The pet feeder of claim 1, wherein the grain storage container further comprises a guide member located inside the accommodating space, the guide member being arranged obliquely and directed toward the grain outlet to facilitate gravity feeding of grain.

14. The pet feeder of claim 1, wherein the grain storage container is further provided with a grain inlet in communication with the accommodating space.

15. The pet feeder of claim 14, wherein the grain storage container further comprises a sealing cover, and the sealing cover is removably connected to the grain storage container to cover and seal the grain inlet.

16. The pet feeder of claim 15, wherein a bottom of the sealing cover is provided with a locking member, wherein rotation of the locking member causes the locking member to simultaneously abut against the sealing cover and an inner wall of the grain storage container to secure the sealing cover in a closed position.

17. The pet feeder of claim 1, wherein the grain storage container is further provided with an observation window located at a front end of the grain storage container.

18. The pet feeder of claim 1, further comprising a support assembly connected to a bottom of the grain storage container.

19. The pet feeder of claim 18, wherein the grain storage container has a rectangular structure.

20. The pet feeder of claim 19, wherein the support assembly comprises a plurality of support components, and the plurality of support components are symmetrically arranged at the bottom of the grain storage container.
